(19) United States
(12) Patent Application Publication
(10) Pub. No.: US 2025/0052858 A1
(43) Pub. Date: Feb. 13, 2025

(54) RADIOFREQUENCY SENSING USING RADIOFREQUENCY SENSING STATIONS

(71) Applicant: DEUTSCHE TELEKOM AG, Bonn (DE)

(72) Inventor: Axel KLATT, Cologne (DE)

(21) Appl. No.: 18/723,496

(22) PCT Filed: Jan. 9, 2023
(86) PCT No.: PCT/EP2023/050311

§ 371 Date: Jun. 24, 2024

(30) Foreign Application Priority Data
Jan. 12, 2022 (EP) 22151120.7

(51) Int. Cl. G01S 7/282; G01S 7/00; G01S 13/00

(52) U.S. Cl. CPC G01S 7/282; G01S 7/006; G01S 13/003

(57) ABSTRACT

A method for conducting radiofrequency sensing involving a first radiofrequency sensing station and at least a second radiofrequency sensing station includes: transmitting, by the first radiofrequency sensing station a radiofrequency sensing signal; receiving, by the second radiofrequency sensing station, as a result of the radiofrequency sensing signal being transmitted, a radiofrequency sensing reception signal, wherein the radiofrequency sensing reception signal corresponds to the radiofrequency sensing signal being transmitted on a direct path or being reflected; and deriving, based on the radiofrequency sensing reception signal, information regarding properties of a transmission channel between the first and second radiofrequency sensing stations and/or regarding an object that reflects the radiofrequency sensing signal. The radiofrequency sensing signal uses transmission resources specifically assigned or associated to the first radiofrequency sensing station.

### CROSS-REFERENCE TO PRIOR APPLICATIONS

This application is a U.S. National Phase application under 35 U.S.C. § 371 of International Application No. PCT/EP2023/050311, filed on Jan. 9, 2023, and claims benefit to European Patent Application No. EP 22151120.7, filed on Jan. 12, 2022. The International Application was published in English on Jul. 20, 2023 as WO 2023/135076 A1 under PCT Article 21(2).

### FIELD

The present invention relates a method for conducting radiofrequency sensing involving a first radiofrequency sensing station and at least a second radiofrequency sensing station, wherein the first radiofrequency sensing station transmits a radiofrequency sensing signal, wherein, as a result of the radiofrequency sensing signal being transmitted, a radiofrequency sensing reception signal is received by the second radiofrequency sensing station, the radiofrequency sensing reception signal corresponding to or comprising direct path-transmitted radiofrequency sensing signal and/or a reflection of the radiofrequency sensing signal, allowing to derive, based on the radiofrequency sensing reception signal, information regarding transmission channel properties between the first and second radiofrequency sensing station and/or regarding an object that reflects the radiofrequency sensing signal.

Additionally, the present invention relates to a system or a mobile communication network for conducting radiofrequency sensing involving a first radiofrequency sensing station and at least a second radiofrequency sensing station as part of the system or mobile communication network, wherein the first radiofrequency sensing station transmits a radiofrequency sensing signal, wherein, as a result of the radiofrequency sensing signal being transmitted, a radiofrequency sensing reception signal is received by the second radiofrequency sensing station, the radiofrequency sensing reception signal corresponding to or comprising direct path-transmitted radiofrequency sensing signal and/or a reflection of the radiofrequency sensing signal, allowing to derive, based on the radiofrequency sensing reception signal, information regarding transmission channel properties between the first and second radiofrequency sensing station and/or regarding an object that reflects the radiofrequency sensing signal.

Furthermore, the present invention relates to a radiofrequency sensing station for conducting radiofrequency sensing, the radiofrequency sensing station being used as a first radiofrequency sensing station and/or as a second radiofrequency sensing station in a system or in a mobile communication network, or as a part thereof, according to the present invention.

Furthermore, the present invention relates to a program and to a computer-readable medium for conducting network selection and/or cell selection according to the present invention.

### BACKGROUND

Mobile communication networks such as public land mobile networks are typically realized as cellular mobile communication networks, i.e. comprising (or using or being associated or assigned to a radio access network comprising) radio cells. Such cellular systems are known conforming to different mobile communication standards or radio access technologies, like 2G/3G/4G/5G/6G radio access technologies (referring to the different generations of radio access technologies) and typically comprise (or consist of) cells (or radio cells) of one or a plurality of the respective radio access technology/radio access technologies, which are typically organized throughout a country (or a part of or a region within a country) in a repeating pattern of (radio) cells (and associated base station entities) which belong to (or are used by or associated or assigned to) a mobile network operator (MNO).

Via realizing sensing capabilities in such communication networks, primarily via one or a plurality of radiofrequency sensing stations generating and transmitting radiofrequency sensing signals, it is possible to obtain information regarding either transmission channel properties between different stations, especially base station entities, and/or regarding objects from where such radiofrequency sensing signals are reflected.

Even though such sensing capabilities are able to procure further information regarding transmission channels and/or objects, especially moving objects, nearby or in the vicinity of the respective radiofrequency sensing stations, in order to realize such sensing capabilities, additional efforts (in the sense of additional technical equipment and/or in the sense of additional technical procedures) and/or the use of valuable radiofrequency transmission resources of the air interface of the mobile communication network are typically required. Hence, a manner is required to maximize the possibility to obtain additional information while simultaneously to minimize the additional efforts and/or the use of transmission resources of the air interface.

### SUMMARY

In an exemplary embodiment, the present invention provides a method for conducting radiofrequency sensing involving a first radiofrequency sensing station and at least a second radiofrequency sensing station. The method includes: transmitting, by the first radiofrequency sensing station a radiofrequency sensing signal; receiving, by the second radiofrequency sensing station, as a result of the radiofrequency sensing signal being transmitted, a radiofrequency sensing reception signal, wherein the radiofrequency sensing reception signal corresponds to the radiofrequency sensing signal being transmitted on a direct path or being reflected; and deriving, based on the radiofrequency sensing reception signal, information regarding properties of a transmission channel between the first and second radiofrequency sensing stations and/or regarding an object that reflects the radiofrequency sensing signal. The radiofrequency sensing signal uses transmission resources specifically assigned or associated to the first radiofrequency sensing station.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a mobile communication network comprising or interworking with a first radiofrequency sensing station as well as a second radiofrequency sensing station for conducting radiofrequency sensing, the first radiofrequency sensing station transmitting a radiofrequency sensing signal and the second radiofrequency sensing station receiving a radiofrequency sensing reception signal that is received as a result of the radiofrequency sensing signal being transmitted.

FIG. 2 schematically illustrates the first and second radiofrequency sensing stations together with a representation of transmission resources being specifically assigned or associated to the first or the second radiofrequency sensing station, respectively.

### DETAILED DESCRIPTION

Exemplary embodiments of the present invention provide a technically simple, effective and cost-effective solution for conducting radiofrequency sensing allowing to efficiently derive information regarding transmission channel properties between different stations and/or regarding an object that reflects the radiofrequency sensing signal. Further exemplary embodiments of the present invention provide a corresponding system or mobile communication network, radiofrequency sensing station and a corresponding program and computer-readable medium.

In an exemplary embodiment, the present invention provides a method for conducting radiofrequency sensing involving a first radiofrequency sensing station and at least a second radiofrequency sensing station, wherein the first radiofrequency sensing station transmits a radiofrequency sensing signal, wherein, as a result of the radiofrequency sensing signal being transmitted, a radiofrequency sensing reception signal is received by the second radiofrequency sensing station, the radiofrequency sensing reception signal corresponding to or comprising direct path-transmitted radiofrequency sensing signal and/or a reflection of the radiofrequency sensing signal, allowing to derive, based on the radiofrequency sensing reception signal, information regarding transmission channel properties between the first and second radiofrequency sensing station and/or regarding an object that reflects the radiofrequency sensing signal, wherein, in order to conduct the radiofrequency sensing, the method comprises the following steps:
in a first step, the radiofrequency sensing signal is transmitted by the first radiofrequency sensing station and the corresponding radiofrequency sensing reception signal is received by the second radiofrequency sensing station, wherein the radiofrequency sensing signal uses transmission resources specifically assigned or associated to the first radiofrequency sensing station,
in a second step, based on the radiofrequency sensing reception signal, at least one piece of information regarding the transmission channel properties between the first and second radiofrequency sensing station and/or regarding the object is derived.

It is thereby advantageously possible according to the present invention that radiofrequency sensing is able to be performed in a comparatively easy and straight-forward manner, and that it is possible—via the radiofrequency sensing signal using transmission resources specifically assigned or associated to the first radiofrequency sensing station—for the second radiofrequency sensing station (or any station receiving the radiofrequency sensing reception signal) to know that it is the first radiofrequency sensing station from where the received signal is originating, i.e. only via receiving the respective signal (and, consequently, thereby being able to determine the transmission resources used for generating the respective signal), the identity of the transmitting radiofrequency sensing station (i.e. the first radiofrequency sensing station in the situation considered) is able to be determined by the second radiofrequency sensing station (or any other receiving station).

According to the present invention, a solution is provided for being able to efficiently conducting radiofrequency sensing.

Conventionally, radiofrequency sensing may refer to a radiofrequency sensing station transmitting a radiofrequency sensing signal, and wherein this radiofrequency sensing signal is reflected by an object—especially a movable object, e.g. a vehicle or a drone or the like —, and a corresponding radiofrequency sensing reception signal (i.e. corresponding to the radiofrequency sensing signal) being received by the same radiofrequency sensing station. In such a situation, it might be possible for the radiofrequency sensing station to infer the distance of the object from the time interval between the sensing signal and the sensing reception signal, or the movement of the object from an increasing and/or decreasing time interval between repeated sensing signals and corresponding sensing reception signal. Furthermore, with improved active antenna technology such as beamforming antennas, an angular resolution of the reflecting object can be achieved.

However, a faster and/or more complete and/or more precise characterization of the object, especially its localization, might be possible if the considered radiofrequency sensing reception signal would be a signal being received by another station (i.e. different from the station transmitting the radiofrequency sensing signal); especially, this would allow for, among other possibilities, conducting triangulation techniques to infer, e.g., the position of the moving object, and, in addition—via considering the direct path-transmitted radiofrequency sensing signal as the radiofrequency sensing reception signal —, properties of the transmission channel between both radiofrequency sensing stations.

Hence, according to the present invention, the possibility of radiofrequency sensing is addressed involving a first radiofrequency sensing station and at least a second radiofrequency sensing station (typically located at a certain geographical distance from the first radiofrequency sensing station, the distance ranging, e.g., from at least several meters or several tens or hundreds of meters to several kilometers or even several tens or kilometers). The first radiofrequency sensing station transmits a radiofrequency sensing signal, and, as a result of the radiofrequency sensing signal being transmitted, a radiofrequency sensing reception signal is received by the second radiofrequency sensing station. The radiofrequency sensing reception signal corresponds to or comprises the direct path-transmitted radiofrequency sensing signal and/or a reflection of the radiofrequency sensing signal, allowing to derive, based on the radiofrequency sensing reception signal, information regarding transmission channel properties between the first and second radiofrequency sensing station and/or regarding an object that reflects the radiofrequency sensing signal. However, in order to be able to derive such pieces of information (regarding transmission channel properties and/or regarding an object reflecting the radiofrequency sensing signal) from the radiofrequency sensing reception signal received by the second radiofrequency sensing station necessarily requires knowledge about certain properties of the radiofrequency sensing signal, such as the transmission time, the location from where the signal has been transmitted and the like.

According to the present invention, the method comprises the step of transmitting the radiofrequency sensing signal, by the first radiofrequency sensing station, and receiving the corresponding radiofrequency sensing reception signal, by the second radiofrequency sensing station, wherein the radiofrequency sensing signal uses (radio) transmission resources specifically assigned or associated to the first radiofrequency sensing station (i.e. the station transmitting the radiofrequency sensing signal). In a subsequent (second) step, based on the radiofrequency sensing reception signal, at least one piece of information regarding the transmission channel properties between the first and second radiofrequency sensing station and/or regarding the object is derived.

According to the present invention, the terms “transmission resources” or “radio transmission resources” especially refer to the air interface the (first) radiofrequency sensing station uses to transmit radiofrequency signals. Typically, such transmission resources used by the mobile communication network are organized in a certain frequency domain structure as well as a certain time domain structure, i.e. for the radiofrequency sensing signal a certain frequency or frequency band or frequency carrier or sub-carrier is used and it is transmitted at a certain point in time or during a certain time interval. Such frequency domain structures as well as time domain structures may differ between different radio access technologies or different generations of mobile communication networks or technologies but are commonly used among radiofrequency sensing stations using the same radio access technology.

According to the present invention, it is advantageously possible to include sensing capabilities in communication networks. Preferably, the same components of the radio access network of (or associated with) a mobile communication network should be used to provide communication on the one hand while providing radiofrequency sensing technology on the other hand.

According to the present invention, it is advantageously possible and preferred that in case that the radiofrequency sensing signal, and, as a consequence, also the radiofrequency sensing reception signal, is structured such that it comprises, or carries, at least one out of the following:
an indication regarding or related to its time of transmission, especially a time stamp information of the transmission time,
an indication regarding or related to the location of the first radiofrequency sensing station, especially its coordinates and/or height,
an indication regarding or related to the identity of the first radiofrequency sensing station,
an indication regarding or related to a specific radiofrequency sensing signal or radiofrequency sensing reception signal out of a sequence of such signals transmitted by the first radiofrequency sensing station,
an indication regarding or related to the transmission angle, especially the rotation and elevation,
an indication regarding or related to the transmission power used,
an indication regarding or related to the signal form of the radiofrequency sensing signal, especially its modulation and/or the signal length,
   wherein especially the radiofrequency sensing signal and/or the radiofrequency sensing reception signal comprises or uses an interoperable signal structure.

It is thereby advantageously possible that via the radiofrequency sensing signal itself (or via the radiofrequency sensing reception signal itself) critical information or pieces of information are able to be provided towards the second radiofrequency sensing station in order to enable the second radiofrequency sensing station (or another network node or station such as a calculation instance) to derive, based on the radiofrequency sensing reception signal, the at least one piece of information regarding the transmission channel properties between the first and second radiofrequency sensing station and/or regarding the object. The indication regarding or related to the identity of the first radiofrequency sensing station, may, e.g., correspond to an integer value physically transmitted as part of (a modulation of) the radiofrequency sensing (reception) signal, whereas a table or a database information or repository, being accessible by the second radiofrequency sensing station, comprises additional information, such as, e.g., the name, identity, location, etc. of the first radiofrequency sensing station. Especially, the indication regarding or related to the identity of the first radiofrequency sensing station may be globally unique; alternatively, this indication is preferably unique only within a typical coverage area of the first radiofrequency sensing station and/or within a location area and/or tracking area.

Analogously, the indication regarding or related to a specific radiofrequency sensing signal or radiofrequency sensing reception signal out of a sequence of such signals transmitted by the first radiofrequency sensing station, may, e.g., correspond to an integer value physically transmitted as part of (a modulation of) the radiofrequency sensing (reception) signal, whereas a table or a database information or repository, being accessible by the second radiofrequency sensing station, comprises additional information, such as, e.g., the transmission time, the transmission power, the transmission angle, especially the rotation and elevation, the signal form of the radiofrequency sensing (reception) signal, especially its modulation and/or the signal length, etc. of the corresponding radiofrequency sensing (reception) signal within the sequence of such signals.

According to the present invention, it is advantageously furthermore possible and preferred that, in the second step and based on the information content of the radiofrequency sensing reception signal, the at least one piece of information regarding the transmission channel properties between the first and second radiofrequency sensing station and/or regarding the object, especially the distance and/or the position and/or the location of the object, is determined,

wherein especially this determination is based on, besides the information content of the radiofrequency sensing reception signal, pieces of information available at the second radiofrequency sensing station, or accessible by the second radiofrequency sensing station.

It is thereby advantageously possible according to the present invention that no additional indications regarding the radiofrequency sensing (reception) signal need to be transmitted from the first radiofrequency sensing station to the second radiofrequency sensing station—or, in other words: the second radiofrequency sensing station (or another network node or calculation instance) is able to access or retrieve all necessary information elements in order to be able to derive the interesting pieces of information regarding the transmission channel properties between the first and second radiofrequency sensing station and/or regarding the object.

According to another embodiment of the present invention, it is furthermore advantageously possible and preferred that, in the second step, the at least one piece of information regarding the transmission channel properties between the first and second radiofrequency sensing station and/or regarding the object, especially the distance and/or the position and/or the location of the object, is determined based on the information content of the radiofrequency sensing reception signal in addition to at least one piece of information that is related to the radiofrequency sensing and radiofrequency sensing reception signals and received from the first radiofrequency sensing station.

It is thereby advantageously possible according to such an embodiment of the present invention that the first radiofrequency sensing station provides, to the second radiofrequency sensing station (or to another network node or calculation instance), additional indications (or information elements) regarding or in view of interpreting the radiofrequency sensing (reception) signal.

Furthermore, it is advantageously possible and preferred according to the present invention that the first radiofrequency sensing station is a base station entity (first base station entity) of a mobile communication network, especially a gNB-station as part of a radio access network of the mobile communication network, the first radiofrequency sensing station especially being able to serve at least one first user equipment,

wherein the radiofrequency sensing signal is or corresponds to a radiofrequency signal required for communication purposes between the first radiofrequency sensing station and the at least one first user equipment, wherein especially the radiofrequency signal required for communication purposes between the first radiofrequency sensing station and the at least one first user equipment corresponds to a broadcast signal, especially carrying a piece of system information.

Via the first radiofrequency sensing station being a base station entity of the mobile communication network, a method and system according to an exemplary embodiment of the present invention are able to be implemented in an especially efficient manner.

Furthermore, it is advantageously possible and preferred according to the present invention that the second radiofrequency sensing station is likewise a base station (second base station entity) entity of a mobile communication network, especially a gNB-station as part of a radio access network of the mobile communication network, the second radiofrequency sensing station especially being able to serve at least one second user equipment,

wherein the second radiofrequency sensing station is configured to receive the radiofrequency sensing reception signal, especially receive the radiofrequency sensing reception signal simultaneously to a radiofrequency signal related to communication purposes between the second user equipment and the second radiofrequency sensing station.

Via the second radiofrequency sensing station being a base station entity of the mobile communication network, a method and system according to an exemplary embodiment of the present invention are able to be implemented in an especially efficient manner.

According to a further preferred embodiment of the present invention, the at least one piece of information regarding the transmission channel properties between the first and second radiofrequency sensing station and/or regarding the object, especially the distance and/or the position and/or the location of the object, is provided to an entity or network node of the mobile communication network, especially a calculation instance or a repository instance,

wherein especially the second step is performed by the second radiofrequency sensing station or by an entity or network node of the mobile communication network, especially a calculation instance.

Thereby, it is advantageously possible to implement a method and system according to an exemplary embodiment of the present invention in an especially efficient manner.

According to a further preferred embodiment of the present invention, the transmission resources, especially the time resources and/or the frequency resources, used for transmitting the radiofrequency sensing signal are assigned or associated to the first radiofrequency sensing station in a unique manner within a typical coverage area of the first radiofrequency sensing station and/or within a location area and/or tracking area, wherein especially the identity of the first radiofrequency sensing station is able to be determined based on the transmission resources used for transmitting the radiofrequency sensing signal.

It is thereby advantageously possible to be able to repeat the use of a considered set of transmission resources among a plurality of different radiofrequency sensing station, provided that such radiofrequency sensing stations are geographically sufficiently spaced to avoid, or to at least limit as much as possible, not only signal interference between such radio frequency signals but also a mismatch (or a misassignment) of the identity of two radiofrequency sensing stations based on a radiofrequency sensing station (acting as a second radiofrequency sensing station, i.e. receiving a radiofrequency sensing reception signal) receiving such radiofrequency signals transmitted by those two radiofrequency sensing stations using the same transmission resources.

Being able to determine (i.e. the radiofrequency sensing station, acting as the second radiofrequency sensing station, being able to determine) the identity of the first radiofrequency sensing station based on, especially solely based on, the transmission resources used by that radiofrequency sensing station provides the possibility to use the radiofrequency sensing signal for radiofrequency sensing purposes but without the need for such a radiofrequency signal to carry any (modulated) information content used for radiofrequency sensing purposes; hence, the information content of the signal is able to be used for operative communication purposes.

Furthermore, it is advantageously possible and preferred according to the present invention that the maximum signal duration or maximum pulse duration of the radiofrequency sensing signal corresponds to 500 μs, preferably to 250 μs, more preferably to 125 μs, more preferably to 62.5 μs, and more preferably to 50 μs or to less than 50 μs, and additionally wherein the minimum signal duration or minimum pulse duration of the radiofrequency sensing signal corresponds to 0.1 μs, preferably to 1 μs, more preferably to 2 μs.

Thereby, it is advantageously possible implement a method and system according to an exemplary embodiment of the present invention in an especially efficient manner.

Furthermore, it is advantageously possible and preferred according to the present invention that the object is located in the vicinity of both the first and second radiofrequency sensing stations, especially within a distance from the center location of the first and second radiofrequency sensing stations within two times or three times or four times the distance between the first and second radiofrequency sensing stations.

Thereby, it is advantageously possible implement a method and system according to an exemplary embodiment of the present invention in an especially efficient manner.

Furthermore, it is advantageously possible and preferred according to the present invention that the first radiofrequency sensing station acts as a second radiofrequency sensing station and either the second radiofrequency sensing station or a further radiofrequency sensing station acts as a first radiofrequency sensing station.

Thereby, it is advantageously possible that all or at least a plurality of radiofrequency sensing stations are able to be used both as a transmitting station (i.e. transmitting the (or its) radiofrequency sensing signal) and as a receiving station (i.e. receiving the radiofrequency sensing reception signal, corresponding to a radiofrequency sensing signal transmitted by another radiofrequency sensing station nearby or in the vicinity).

Furthermore, the present invention relates to a system or mobile communication network for conducting radiofrequency sensing involving a first radiofrequency sensing station and at least a second radiofrequency sensing station as part of the system or mobile communication network, wherein the first radiofrequency sensing station transmits a radiofrequency sensing signal, wherein, as a result of the radiofrequency sensing signal being transmitted, a radiofrequency sensing reception signal is received by the second radiofrequency sensing station, the radiofrequency sensing reception signal corresponding to or comprising the direct path-transmitted radiofrequency sensing signal and/or a reflection of the radiofrequency sensing signal, allowing to derive, based on the radiofrequency sensing reception signal, information regarding transmission channel properties between the first and second radiofrequency sensing station and/or regarding an object that reflects the radiofrequency sensing signal,

wherein, in order to conduct the radiofrequency sensing, the system or mobile communication network is configured such that:
the radiofrequency sensing signal is transmitted by the first radiofrequency sensing station and the corresponding radiofrequency sensing reception signal is received by the second radiofrequency sensing station, wherein the radiofrequency sensing signal uses transmission resources specifically assigned or associated to the first radiofrequency sensing station
based on the radiofrequency sensing reception signal, at least one piece of information regarding the transmission channel properties between the first and second radiofrequency sensing station and/or regarding the object is derived.

Furthermore, the present invention relates to a radiofrequency sensing station being used as a first radiofrequency sensing station and/or as a second radiofrequency sensing station in a system or in a mobile communication network, or as a part thereof, according to the present invention.

Additionally, the present invention relates to a program comprising a computer readable program code which, when executed on a computer and/or on a first radiofrequency sensing station and/or on a second radiofrequency sensing station and/or on a network node of a mobile communication network, or in part on a first radiofrequency sensing station and/or in part on a second radiofrequency sensing station and/or in part on a network node of a mobile communication network, causes the computer and/or the first and/or second radiofrequency sensing station and/or the network node of the mobile communication network to perform a method according to an exemplary embodiment of the present invention.

Still additionally, the present invention relates to a computer-readable medium comprising instructions which when executed on a computer and/or on a first radiofrequency sensing station and/or on a second radiofrequency sensing station and/or on a network node of a mobile communication network, or in part on a first radiofrequency sensing station and/or in part on a second radiofrequency sensing station and/or in part on a network node of a mobile communication network, causes the computer and/or the first and/or second radiofrequency sensing station and/or the network node of the mobile communication network to perform a method according to an exemplary embodiment of the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

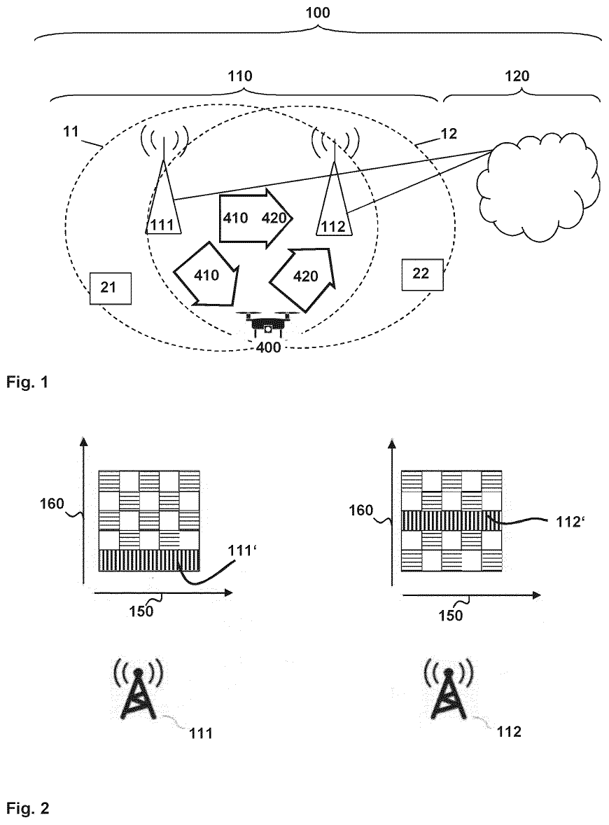

In FIG. 1, schematically illustrates a mobile communication network 100 comprising or interworking with a first radiofrequency sensing station 111 as well as a second radiofrequency sensing station 112 for conducting radiofrequency sensing, the first radiofrequency sensing station 111 transmitting a radiofrequency sensing signal 410 and the second radiofrequency sensing station 112 receiving a radiofrequency sensing reception signal 420 that is received as a result of the radiofrequency sensing signal 410 being transmitted. The radiofrequency sensing signal 410 is schematically illustrated via an arrow, or arrows, emanating from the first radiofrequency sensing station 111, and the radiofrequency sensing reception signal 420 is schematically illustrated via an arrow, or arrows, arriving at the second radiofrequency sensing station 112.

While it is possible that the first radiofrequency sensing station 111 transmits the radiofrequency sensing signal 410 in a direction-dependent manner (e.g. by using active antenna technology, e.g. beamforming antennas, such as to achieve an angular resolution or variation of the transmission power with regard to the radiofrequency sensing signal 410), FIG. 1 primarily shows, as one exemplary implementation, the rather classical transmission of the radiofrequency sensing signal 410 in various directions.

More specifically, FIG. 1 is intended to show, as one possibility, a direct transmission (or direct path-transmission) of the radiofrequency sensing signal 410 from the first radiofrequency sensing station 111 towards or in the direction of the second radiofrequency sensing station 112, and, as another possibility, a transmission of the radiofrequency sensing signal 410 towards or in the direction of an object 400 in the vicinity of the first and second radiofrequency sensing stations 111, 112, especially a moving object 400 such as a vehicle, a drone or the like. Both possibilities (of the radiofrequency sensing signal being transmitted to the second radiofrequency sensing station 112) may also (and will in many circumstances) be realized cumulatively, i.e. the radiofrequency sensing signal 410 is transmitted, and, as a consequence or result thereof, the radiofrequency sensing reception signal 420 received by the second radiofrequency sensing station 112 comprises a (signal) component corresponding to the direct path-transmission as well as a (signal) component corresponding to the reflection, by the object 400, of the radiofrequency sensing signal 410 in the direction of the second radiofrequency sensing station 112.

Of course, besides considering the direct path-transmission and considering one reflection at the object 400, there is also the possibility of at least one additional reflection (or even a plurality of further or additional reflections) occurring prior to the radiofrequency sensing reception signal 420 being received by the second radiofrequency sensing station 112, leading to further (signal) components of the radiofrequency sensing reception signal 420—however, for the sake of simplicity, this is not explicitly shown in FIG. 1.

Hence, the radiofrequency sensing reception signal 420 is received, by the second radiofrequency sensing station 112, as a result of the radiofrequency sensing signal 410 being transmitted by the first radiofrequency sensing station 111, and from the knowledge of both the radiofrequency sensing signal 410 and the radiofrequency sensing reception signal 420, it is possible to derive an information (or various pieces of information), especially regarding transmission channel properties between the first and second radiofrequency sensing station 111, 112 and/or regarding the object 400 that reflects the radiofrequency sensing signal 410. In the context of the present invention, the terms radiofrequency sensing signal 410 and radiofrequency sensing reception signal 420 are used in order to indicate that a (radiofrequency) signal (i.e. the radiofrequency sensing signal 410), once transmitted by the first radiofrequency sensing station 111, is necessarily altered (such as distorted, attenuated, reflected or the like), and, hence, arrives (or is received) as an at least somehow or somewhat different (radiofrequency) signal (i.e. the radiofrequency sensing reception signal 420) at the reception side, i.e. the second radiofrequency sensing station 112. However, the radiofrequency sensing reception signal 420 is not inherently different from the radiofrequency sensing signal 410, but carries the signal modifications having occurred while being propagated between the first and second radiofrequency sensing stations 111, 112. Furthermore, in the context of the present invention, the two radiofrequency sensing stations 111, 112 are mainly described such that the first radiofrequency sensing station 111 transmits the radiofrequency sensing signal 410 and the second radiofrequency sensing station 112 receives the radiofrequency sensing reception signal 420. However, according to the present invention, the two radiofrequency sensing stations 111, 112 may preferably also be used vice versa, i.e. such that the first radiofrequency sensing station 111 acts as the station receiving a radiofrequency sensing reception signal, i.e. it acts as a second radiofrequency sensing station, and, e.g., the second radiofrequency sensing station 112 (or a still further radiofrequency sensing station, not represented in FIG. 1) acts as the station transmitting a radiofrequency sensing signal, i.e. it (the second radiofrequency sensing station) acts as a first radiofrequency sensing station. Thus, all (or at least a plurality of) radiofrequency sensing stations are able to be used both as a transmitting station (i.e. transmitting the (or its) radiofrequency sensing signal) and as a receiving station (i.e. receiving the radiofrequency sensing reception signal, the radiofrequency sensing reception signal corresponding to a radiofrequency sensing signal transmitted by another radiofrequency sensing station nearby or in the vicinity).

In the example shown in FIG. 1, the mobile communication network 100 comprises an access network 110 and a core network 120. The mobile communication network 100 is preferably a cellular telecommunications network comprising typically a plurality of network cells (or radio cells), generated or served by a corresponding base station entity, and each network cell or radio cell (or its corresponding base station entity) having a radio coverage area. Typically, the base station entities of a mobile communication network 100 correspond to terrestrial base station entities, i.e. stationary and non-movable stations having, respectively, a generally fixed position or location. However, according to the present invention, it is not excluded that one or a plurality of base station entities of the mobile communication network 100 are provided as air-based or space-based base station entities, i.e. non-terrestrial base station entities, being movable or having a changing or time-dependent position or location.

According to the present invention, it is preferred (but not mandatorily the case) that the first radiofrequency sensing station 111 is or corresponds to a base station entity of the mobile communication network 100, especially a gNB-station, as part of the radio access network 110 of the mobile communication network 100, having a radio coverage area (or (first) radio cell) indicated via reference sign 11 and a dashed line in FIG. 1. In this case (that the first radiofrequency sensing station 111 is or corresponds to a base station entity of the mobile communication network 100), the first radiofrequency sensing station 111 is preferably able to serve at least one first user equipment 21 being located within its radio cell 11 (or first radio cell 11), and the first radiofrequency sensing station 111 is also called first base station entity 111—i.e. these terms are used synonymously. Typically, the first base station entity 111 is able to serve more than one (first) user equipment located in the first radio cell 11.

Likewise preferably, the second radiofrequency sensing station 112 is or corresponds to a base station entity of the mobile communication network 100, especially a gNB-station, likewise as part of the radio access network 110 of the mobile communication network 100, having a radio coverage area (or (second) radio cell) indicated via reference sign 12 and a further dashed line in FIG. 1. In this case (that the second radiofrequency sensing station 112 is or corresponds to a base station entity of the mobile communication network 100), the second radiofrequency sensing station 112 is preferably able to serve at least one second user equipment 22 being located within its radio cell 12 (or second radio cell 12), and the second radiofrequency sensing station 112 is also called second base station entity 112—i.e. these terms are used synonymously. Typically, the second base station entity 112 is able to serve more than one (second) user equipment located in the second radio cell 12.

According to the present invention, the method for conducting radiofrequency sensing (involving the first radiofrequency sensing station 111—or first base station entity 111—and the at least second radiofrequency sensing station 112—or second base station entity 112), comprises the steps of.
in the first step, the radiofrequency sensing signal 410 is transmitted by the first radiofrequency sensing station 111 using transmission resources specifically assigned or associated to the first radiofrequency sensing station 111,
in the second step, based on the radiofrequency sensing reception signal 420 (corresponding to the radiofrequency sensing signal 410) being (or having been) received by the second radiofrequency sensing station 112, at least one piece of information regarding the transmission channel properties between the first and second radiofrequency sensing station 111, 112 and/or regarding the object 400 is derived or is able to be derived.

As an example of an information or a piece of information regarding the object 400, e.g. the position or location of the object 400 and/or its velocity may be derived based on the radiofrequency sensing reception signal 420, especially based on analyzing a (signal) portion or part thereof arriving slightly delayed compared to the direct path-transmitted signal. As an example of an information or a piece of information regarding the transmission channel properties between the first and second radiofrequency sensing station 111, 112, e.g. the current signal attenuation or multi-path propagation characteristics may be derived based on the radiofrequency sensing reception signal 420.

In FIG. 2, the first and a second radiofrequency sensing stations 111, 112, together with a representation of transmission resources being specifically assigned or associated to the first or the second radiofrequency sensing station 111, 112, respectively, are schematically represented.

These (radio) transmission resources refer to the air interface that the first radiofrequency sensing station 111 (or first base station entity 111) or the second radiofrequency sensing station 112 (or second base station entity 112) uses to transmit radiofrequency signals.

Typically, such transmission resources used by the mobile communication network 100 are organized in a certain frequency domain structure as well as a certain time domain structure, i.e. for the radiofrequency sensing signal 410, a certain frequency or frequency band or frequency carrier or sub-carrier is used and it is transmitted at a certain point in time or during a certain time interval. Such frequency domain structures as well as time domain structures may differ between different radio access technologies or different generations of mobile communication networks or technologies but are commonly used among radiofrequency sensing stations 111, 112 (or base station entities 111, 112) using the same radio access technology. In FIG. 2, a time domain structure 150 as well as a frequency domain structure 160 is schematically shown for both the first radiofrequency sensing station 111 and the second radiofrequency sensing station 112. The schematical diagram-like representations of time-frequency resources are intended to represent the identical (part of the) available transmission resources of the air interface used by these radiofrequency sensing stations and/or base station entities 111, 112.

Typically, (radio) transmission resources may be organized in resource blocks or physical resource blocks, wherein one of the horizontally hatched blocks (or one of the blank blocks) represented in FIG. 2 is exemplarily intended to represent such a resource block or physical resource block or part thereof. Likewise, the vertically hatched portions or parts of the (radio) transmission resources—represented on the left hand side for the first radiofrequency sensing station (or first base station entity) 111 and on the right hand side for the second radiofrequency sensing station (or second base station entity) 112—also correspond to some (radio) transmission resources in the sense of one or a plurality of resource blocks or physical resource blocks or a part of a resource block or a part of a physical resource block. As can be seen even from the schematical representation in FIG. 2, the (radio) transmission resources 111′ specifically assigned or associated to the first radiofrequency sensing station 111 (or first base station entity 111)—hereinafter also referred to as first (radio) transmission resources 111′—are located (or comprise) a different frequency (or frequency interval or frequency band or carrier or sub-carrier) in the frequency domain 160 compared to the (radio) transmission resources 112′ specifically assigned or associated to the second radiofrequency sensing station 112 (or second base station entity 112)—hereinafter also referred to as second (radio) transmission resources 112′. Regarding the time-domain 150, both the first and second (radio) transmission resources 111′, 112′ are schematically shown as occupying the same time slots. As an alternative to the representation shown in FIG. 2, the first and second (radio) transmission resources 111′, 112′ could also be occupying different time slots in the time domain 150 (but the same frequency (or frequency interval or frequency band or carrier or sub-carrier) in the frequency domain 160). Furthermore alternatively (and likewise not represented in FIG. 2), the first and second (radio) transmission resources 111′, 112′ could also be organized to occupy different time slots in the time domain 150 as well as different frequencies (or frequency intervals or frequency bands or carriers or sub-carriers) in the frequency domain 160.

As already mentioned, in order to leverage the potential of radiofrequency sensing, especially in deriving pieces of information (regarding transmission channel properties and/or regarding objects, especially moving objects) reflecting the radiofrequency sensing signal) from the radiofrequency sensing reception signal received by the second radiofrequency sensing station, not only the radiofrequency sensing reception signal is to be analyzed but also certain properties of the radiofrequency sensing signal are to be known (by the entity deriving such pieces of information, such as the second radiofrequency sensing station 112 or another network node of the mobile communication network 100). According to the present invention, as the radiofrequency sensing signal 410 uses transmission resources 111′ specifically assigned or associated to the first radiofrequency sensing station (111), even without the radiofrequency sensing signal 410 explicitly carrying (e.g. in the sense of a modulated signal) an information identifying the first radiofrequency sensing station 111, upon reception of the corresponding radiofrequency sensing reception signal 420, it is possible (for the analyzing entity) to know the originator thereof (i.e. the first radiofrequency sensing station 111 having transmitted the corresponding radiofrequency sensing signal 410). It is especially preferred according to the present invention, that the transmission resources 111′ (especially the time resources and/or the frequency resources) used for transmitting the radiofrequency sensing signal 410 are assigned or associated to the first radiofrequency sensing station 111 in a unique manner within a typical coverage area of the first radiofrequency sensing station (111) and/or within a location area and/or tracking area. Hence, within a part of the mobile communication network 100 (especially a geographical region such as a location area or a tracking area) the unique assignment of the transmission resources 111′ to the first radiofrequency sensing station 111 allows the second radiofrequency sensing station 112 (receiving the radiofrequency sensing reception signal 420 corresponding to the radiofrequency sensing signal 410) to know the identity of the first radiofrequency sensing station 111. In case that also the transmission timing (within the allotted time slot (or time slots) of the transmission resources 111′) is available (due to the first radiofrequency sensing station 111 conforming to a predefined transmission pattern) to the second radiofrequency sensing station 112 (e.g. via a database comprising the predefined transmission pattern or characteristics thereof), the second radiofrequency sensing station 112 (or another entity or instance, such as a calculation instance) is able to derive the respective pieces of information (regarding transmission channel properties and/or regarding objects (especially moving objects) reflecting the radiofrequency sensing signal).

In case that the first radiofrequency sensing station 111 is a base station entity of the mobile communication network 100 (and, hence, the first radiofrequency sensing station 111 typically being able to serve the at least one first user equipment 21, located within the first radio cell 11), it is advantageously possible and preferred according to the present invention that the radiofrequency sensing signal 410 is or corresponds to a radiofrequency signal required for communication purposes between the first radiofrequency sensing station 111 (i.e. the first base station entity 111) and the at least one first user equipment 21. This means that the transmission resources 111′ used for sensing purpose do not necessarily need to be ‘wasted’ (in the sense of not being able to be operatively used, i.e. for communication purposes) but are able to be received both by the at least one first user equipment 21—for (operative) communication purposes—and by the second radiofrequency sensing station 112—for sensing purposes. Especially, such an operatively used radiofrequency signal (i.e. required for communication purposes between the first radiofrequency sensing station 111 and the at least one first user equipment 21) corresponds to a broadcast signal, especially carrying a piece of system information (of the first radiofrequency sensing station 111 or first base station entity 111). Typically, in order to receive such an operatively used radio frequency signal (from the first base station entity 111), the neighboring second base station entity 112 needs to be modified somehow (especially regarding its reception capabilities), as normally transmission resources are distributed (or assigned) in a manner such that the need (or even the risk) of neighboring (or nearby) base station entities effectively receiving broadcast signals from each other is typically avoided.

Hence, in case that the second radiofrequency sensing station 112 is a base station entity of the mobile communication network 100 (and, hence, the second radiofrequency sensing station 112 typically being able to serve at least one second user equipment 22, located within the second radio cell 12), it is advantageously possible and preferred according to the present invention that the second radiofrequency sensing station 112 is configured to receive the radiofrequency sensing reception signal 420, especially receive the radiofrequency sensing reception signal 420 simultaneously to a radiofrequency signal related to communication purposes between the second user equipment 22 and the second radiofrequency sensing station 112.

One especially advantageous possibility according to the present invention is the reuse for radiofrequency sensing purposes of (operative) radiofrequency signals (used for communication purposes), especially between the first radiofrequency sensing station 111 and the at least one first user equipment 21, in case that beam sweeping is used to transmit such radiofrequency signals to the at least one first user equipment 21.

In case that the radiofrequency sensing signal 410 is transmitted for communication purposes as well, there are no or almost no transmission resources specifically ‘wasted’ for radiofrequency sensing. In case that the radiofrequency sensing signal 410 is not used for communication purposes or not only used for communication purposes, the signal is able to be modified or specifically configured in view of sensing purposes, e.g. with respect to its signal duration and/or with respect to the information content it carries.

Regarding signal duration of the radiofrequency sensing signal 410, it is especially preferred that the maximum signal duration or maximum pulse duration of the radiofrequency sensing signal 410 corresponds to 500 μs, preferably to 250 μs, more preferably to 125 μs, more preferably to 62.5 μs, and more preferably to 50 μs or to less than 50 μs, and additionally that the minimum signal duration or minimum pulse duration of the radiofrequency sensing signal 410 corresponds to 0.1 μs, preferably to 1 μs, more preferably to 2 μs. Typically, the shorter the signal duration of the radiofrequency sensing signal 410, the better is the special resolution potential when analyzing the radiofrequency sensing reception signal 420; however, a longer signal duration provides the possibility for the radiofrequency sensing signal 410 to carry more pieces of information.

Typically, within or regarding the new radio (NR) standard, the normal transmission time is 0.5 milliseconds which corresponds to 500 μs pulse duration; however, certain radio configurations use a symbol length down to 62.5 μs and even less if mini-slot configuration is involved, and typically with further technology development this pulse duration will be further minimized, so that better resolution for sensing will become applicable.

Regarding to the information content of the radiofrequency sensing signal 410, it is preferred that the radiofrequency sensing signal 410, and, as a consequence, also the radiofrequency sensing reception signal 420, is structured such that it comprises, or carries, at least one out of the following:
an indication regarding or related to its time of transmission, especially a time stamp information of the transmission time,
an indication regarding or related to the location of the first radiofrequency sensing station 111, especially its coordinates and/or height,
an indication regarding or related to the identity of the first radiofrequency sensing station 111,
an indication regarding or related to a specific radiofrequency sensing signal 410 or radiofrequency sensing reception signal 420 out of a sequence of such signals transmitted by the first radiofrequency sensing station 111,
an indication regarding or related to the transmission angle, especially the rotation and elevation,
an indication regarding or related to the transmission power used,
an indication regarding or related to the signal form of the radiofrequency sensing signal 410, especially its modulation and/or the signal length,
   wherein especially the radiofrequency sensing signal 410 and/or the radiofrequency sensing reception signal 420 comprises or uses an interoperable signal structure, especially a signal structure that is applicable to be used between mobile communication network equipment of different vendors.

Generally according to the present invention, it is proposed to make the radiofrequency sensing system universal and interoperable by introducing at least a known or defined signal structure to either carry information about the transmission or to implicitly transport information about the transmission. In this respect, it is possible and preferred according to the present invention, to use a “mini-slot”-type of transmission.

Especially, it is proposed to define the radiofrequency sensing signal 410 by re-using the physical layer structure of new radio (NR) or its evolution containing information about at least one out of:
definition of signal form (modulation, signal length, etc.),
transmission power (Tx power),
time of transmission (timestamp at Tx with ns accuracy),
transmission location (long/latitude/height),
transmission angle (rotation and elevation in degree),
transmission station identity.

With this information as part of the backscattered signal (i.e. the radiofrequency sensing reception signal 420, or, in other words, the signal which is reflected by the object 400), the second radiofrequency sensing station 112 is able to receive the signal and calculate the distance and the position of the scatterer (i.e. the object 400) from its reception point (i.e. the location of the second radiofrequency sensing station 112). With this information alone, the second radiofrequency sensing station 112 is in the position to do the full calculation as if the radiofrequency sensing signal 410 was sent from itself.

According to a preferred variant or embodiment of the present invention, the system is applied or implemented by combining the multiple transmissions and the knowledge of the transmission characteristics and the receptions and by doing this joint detection of scattering signals (or reflection signals), the accuracy of the position estimate for the scattering or reflecting object 400 is able to be improved. An exchange of the received information between the different nodes (i.e. between the first and second radiofrequency sensing station 111, 112) or the information forwarding to a central calculation Instance is needed for this. The data format of the received information are preferably defined in a standardized manner.

Depending on the deployment situation it may be needed to exclude some receiver to avoid direct path from Tx to Rx, e.g. all receivers which reside in the direction of the transmission might be filtered out.

In order to enable interference-free or minimized transmission of the sensing signals (i.e. the radiofrequency sensing signal and the radiofrequency sensing reception signal), a coordination of the time and/or frequency resources to be used for the sensing signal transmission is typically required. In case of TDD (time division duplex) transmission being implemented in the mobile communication network 100 (as it is the case, e.g., in today's new radio networks (NR, i.e. 5G systems) that requires a tightly time synchronized manner of operation (due to their TDD transmission), this can be used as time basis. An entity in the mobile communication network 100 can be used as a coordination entity in the NG-RAN.

This is, e.g., a gNB which acts as a coordinating-gNB (or master-gNB), or, alternatively, negotiated between different gNBs or in an open O-RAN-based architecture deployment the RIC (Radio Intelligent Controller). According to the present invention, preferably at least time resource coordination or frequency resource coordination for sensing signals is applied; in an enhanced embodiment, both time and frequency coordination is applied.

E.g., a pseudo RRC signaling in ASN.1 may be as follows:

```
SensingSignalTX: Carries about the details of Sensing Transmission
SensingSignalTX ::= SEQUENCE
            {
            SensingTxPulseForm shape, length
            SensingTxPower -xx... +yy dBm
            SensingTxTimestamp TT:HH:MM:SS:ms:μs or integer
            SensingTxLocation Long, Lat, Height
            SensingTxOrientation Rotation, Elevation
            SensingTxStationId Identity
            }
lateNonCriticalExtension OCTET STRING OPTIONAL,
...
}
```

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for conducting radiofrequency sensing involving a first radiofrequency sensing station and at least a second radiofrequency sensing station, comprising:
transmitting, by the first radiofrequency sensing station a radiofrequency sensing signal;
receiving, by the second radiofrequency sensing station, as a result of the radiofrequency sensing signal being transmitted, a radiofrequency sensing reception signal, wherein the radiofrequency sensing reception signal corresponds to the radiofrequency sensing signal being transmitted on a direct path or being reflected; and
deriving, based on the radiofrequency sensing reception signal, information regarding properties of a transmission channel between the first and second radiofrequency sensing stations and/or regarding an object that reflects the radiofrequency sensing signal;
wherein the radiofrequency sensing signal uses transmission resources specifically assigned or associated to the first radiofrequency sensing station.

2. The method according to claim 1, wherein the radiofrequency sensing signal is structured such that it comprises; or carries; at least one out of the following:
an indication regarding a time of transmission;
an indication regarding a location of the first radiofrequency sensing station;
an indication regarding an identity of the first radiofrequency sensing station;
an indication regarding a specific radiofrequency sensing signal out of a sequence of radiofrequency sensing signals transmitted by the first radiofrequency sensing station;
an indication regarding a transmission angle;
an indication regarding a transmission power used; or
an indication regarding modulation and/or signal length of the radiofrequency sensing signal.

3. The method according to claim 1, wherein the information regarding the properties of the transmission channel and/or regarding the object comprises a distance, a position, and/or a location of the object, and the information is determined based on information content of the radiofrequency sensing reception signal and information available to the second radio frequency sensing station.

4. The method according to claim 1, wherein the information regarding the properties of the transmission channel and/or regarding the object comprises a distance, a position, and/or a location of the object, and wherein the information is determined based on information content of the radiofrequency sensing reception signal information that is related to the radiofrequency sensing and radiofrequency sensing reception signals and received from the first radiofrequency sensing station.

5. The method according to claim 1, wherein the first radiofrequency sensing station is a base station entity of a mobile communication network configured to serve at least one first user equipment;
wherein the radiofrequency sensing signal is or corresponds to a broadcast signal carrying a piece of system information.

6. The method according to claim 5, wherein the second radiofrequency sensing station is a second base station entity of the mobile communication network configured to serve at least one second user equipment;
wherein the second radiofrequency sensing station is configured to receive the radiofrequency sensing reception signal simultaneously to a radiofrequency signal related to communication purposes between a second user equipment and the second radiofrequency sensing station.

7. The method according to claim 1, wherein the information regarding the properties of the transmission channel and/or regarding the object comprises a distance, a position, and/or a location of the object, and the information is provided to an entity or network node of a mobile communication network;
wherein the deriving is performed by the second radiofrequency sensing station or by the entity or network node of the mobile communication network.

8. The method according to claim 1, wherein the transmission resources used for transmitting the radiofrequency sensing signal are assigned or associated to the first radiofrequency sensing station in a unique manner within a coverage area of the first radiofrequency sensing station and/or within a location area and/or tracking area;
wherein an identity of the first radiofrequency sensing station is determinable based on the transmission resources used for transmitting the radiofrequency sensing signal.

9. The method according to claim 1, wherein a maximum signal duration or maximum pulse duration of the radiofrequency sensing signal is less than or equal to 500 μs.

10. The method according to claim 1, wherein the object is located within a distance from a center location of the first and second radiofrequency sensing stations within four times the distance between the first and second radiofrequency sensing stations.

11. The method according to claim 1, wherein both the first and second radiofrequency sensing stations are configured to receive radiofrequency sensing reception signals.

12. A system for conducting radiofrequency sensing, the system comprising:
a first radiofrequency sensing station; and
a second radiofrequency sensing station;
wherein the first radiofrequency sensing station is configured to transmit a radiofrequency sensing signal;
wherein the second radiofrequency sensing station is configured to receive a radiofrequency sensing reception signal as a result of the radiofrequency sensing signal being transmitted, wherein the radiofrequency sensing reception signal corresponds to the radiofrequency sensing signal being transmitted on a direct path or being reflected;
wherein information regarding properties of a transmission channel between the first and second radiofrequency sensing stations and/or regarding an object that reflects the radiofrequency sensing signal are derivable based on the radiofrequency sensing reception signal;
wherein the radiofrequency sensing signal uses transmission resources specifically assigned or associated to the first radiofrequency sensing station.

13-15. (canceled)

16. One or more non-transitory computer-readable mediums having processor-executable instructions stored thereon for conducting radiofrequency sensing involving a first radiofrequency sensing station and at least a second radiofrequency sensing station, wherein the processor-executable instructions, when executed, facilitate performance of the following:
transmitting, by the first radiofrequency sensing station a radiofrequency sensing signal;
receiving, by the second radiofrequency sensing station, as a result of the radiofrequency sensing signal being transmitted, a radiofrequency sensing reception signal, wherein the radiofrequency sensing reception signal corresponds to the radiofrequency sensing signal being transmitted on a direct path or being reflected; and
deriving, based on the radiofrequency sensing reception signal, information regarding properties of a transmission channel between the first and second radiofrequency sensing stations and/or regarding an object that reflects the radiofrequency sensing signal;
wherein the radiofrequency sensing signal uses transmission resources specifically assigned or associated to the first radiofrequency sensing station.
